(19) United States
(12) Patent Application Publication
(10) Pub. No.: US 2013/0275343 A1
(43) Pub. Date: Oct. 17, 2013

(54) Information System for Nutritional Substances

(71) Applicant: Eugenio Minvielle, Rye, NY (US)

(72) Inventor: Eugenio Minvielle, Rye, NY (US)

(21) Appl. No.: 13/485,900

(22) Filed: May 31, 2012

Related U.S. Application Data
(60) Provisional application No. 61/624,939, filed on Apr. 16, 2012.

(51) Int. Cl. G06F 17/30; G06Q 30/00; G09B 19/00

(52) U.S. Cl. 705/400; 434/127; 707/705; 707/E17.001

(57) ABSTRACT

Disclosed herein is an information system regarding nutritional substances. The nutritional substance information system collects, stores, tracks, and transmits information regarding the creation, preservation, transformation, conditioning and consumption of nutritional substances, and correlates such information with various organizations, entities, industries, and governments outside the nutritional substance supply systems, so as to optimize the production of nutritional substances, as well as optimize the consumption of nutritional substances.

### CROSS REFERENCE TO RELATED APPLICATIONS OR PRIORITY CLAIM

This application claims benefit under 35 U.S.C. 119(e) of U.S. Provisional Patent Application Ser. No. 61/624,939 filed Apr. 16, 2012, the contents of which are incorporated herein by reference in their entirety.

### FIELD OF THE INVENTION

The present inventions relate to an information system for collecting, transmitting and acting upon information relating to nutritional substances.

### BACKGROUND OF THE INVENTION

Massive, multi-dimensional information systems have become commonplace on the internet. There are both general information systems, as well as topic specific systems, geographic specific systems, governmental specific systems, and industry specific systems.

Nutritional substances are traditionally grown (plants), raised (animals) or synthesized (synthetic compounds). Additionally, nutritional substances can be found in a wild, non-cultivated form, which can be caught or collected. While the collectors and creators of nutritional substances generally obtain and/or generate information about the source, history, caloric content and/or nutritional content of their products, they generally do not pass such information along to the users of their products. One reason is the nutritional substance industries have tended to act like “silo” industries. Each group in the food and beverage industry: growers, packagers, processors, distributors, retailers, and preparers work separately, and either shares no information, or very little information, between themselves. There is generally no consumer access to, and little traceability of, information regarding the creation and/or origin, preservation, processing, preparation, or consumption of nutritional substances. It would be desirable for such information be available to the consumers of nutritional substances, as well as all participants in the food and beverage industry—the nutritional substance supply system.

While the nutritional substance supply system has endeavored over the last 50 years to increase the caloric content of nutritional substances produced (which has help reduce starvation in developing countries, but has led to obesity problems in developed countries), maintaining, or increasing, the nutritional content of nutritional substances has been a lower priority. Caloric content refers to the energy in nutritional substances, commonly measured in calories. The caloric content could be represented as sugars and/or carbohydrates in the nutritional substances. The nutritional content of foods and beverages, as used herein, refers to the non-caloric content of these nutritional substances which are beneficial to the organisms which consume these nutritional substances. For example, the nutritional content of a nutritional substance could include vitamins, minerals, proteins, and other non-caloric components which are necessary, or at least beneficial, to the organism consuming the nutritional substances.

While there has recently been greater attention by consumer organizations, health organizations and the public to the nutritional content of foods and beverages, the food and beverage industry has been slow in responding to this attention. One reason for this may be that since the food and beverage industry operates as silos of those who create nutritional substances, those who preserve and transport nutritional substances, those who transform nutritional substances, and those who finally prepare the nutritional substances for consumption by the consumer, there has been no coordination of management of nutritional content. While each of these silo industries may be able to maintain or increase the nutritional content of the foods and beverages they handle, each silo industry has only limited information and control of the nutritional substances they receive, and the nutritional substances they pass along.

As consumers better understand their need for nutritional substances with higher nutritional content, they will start demanding that the food and beverage industry offer products which include higher nutritional content, and/or at least information regarding nutritional content of such products. In fact, consumers are already willing to pay higher prices for higher nutritional content. This can be seen at high-end grocery stores which offer organic, minimally processed, fresh, non-adulterated nutritional substances. Further, as societies and governments seek to improve their constituents' health and lower healthcare costs, incentives and/or mandates will be given to the food and beverage industry to track, maintain, and/or increase the nutritional content of nutritional substances they handle. There will be a need, not only within each food and beverage industry silo to maintain or improve the nutritional content of their products, but an industry-wide solution to allow the management of nutritional content across the entire cycle from creation to consumption. In order to manage the nutritional content of nutritional substances across the entire cycle from creation to consumption, the nutritional substance industry will need to identify, track, measure, estimate, preserve, transform, condition, and record nutritional content for nutritional substances. Of particular importance is the measurement, estimation, and tracking of changes to the nutritional content of a nutritional substance from creation to consumption. This information could be used, not only by the consumer in selecting particular nutritional substances to consume, but could be used by the other food and beverage industry silos, including creation, preservation, transformation, and conditioning, to make decisions on how to create, handle and process nutritional substances. Additionally, those who sell nutritional substances to consumers, such as restaurants and grocery stores, could market and price nutritional substances with higher nutritional content, or minimally degraded nutritional content.

For example, the grower of sweet corn generally only provides basic information as the variety and grade of its corn to the packager, who preserves and ships the corn to a producer for use in a ready-to-eat dinner. The packager may only tell the producer that the corn has been frozen as loose kernels of sweet corn. The producer may only provide the consumer with rudimentary instructions how to cook or reheat the ready-to-eat dinner in a microwave oven, toaster oven or conventional oven, and only tell the consumer that the dinner contains whole kernel corn among the various items in the dinner. Finally, the consumer of the dinner will likely keep her opinions on the quality of the dinner to herself, unless it was an especially bad experience, where she might contact the producer's customer support program to complain. Very minimal, or no, information on the nutritional content of the ready-to-eat dinner is passed along to the consumer. The consumer knows essentially nothing about changes (generally degradation) to the nutritional content of the sweet corn from creation, processing, packaging, cooking, preservation, preparation by consumer, and finally consumption by the consumer.

Consumers' needs are changing as consumers are demanding healthier foods, such as “organic foods.” Customers are also asking for more information about the nutritional substances they consume, such as specific characteristics' relating not only to nutritional content, but to allergens or digestive intolerances. For example, nutritional substances which contain lactose, gluten, nuts, dyes, etc. need to be avoided by certain consumers. However, the producer of the ready-to-eat dinner, in the prior example, has very little information to share other than possibly the source of the elements of the ready-to-eat dinner and its processing steps in preparing the dinner. Generally, the producer of the ready-to-eat dinner does not know the nutritional content and organoleptic state of the product after it has been reheated or cooked by the consumer. For example, the consumer may want to know what proportion of organoleptic properties and/or nutritional content the corn in the ready-to-eat dinner remain after cooking or reheating, and the change in nutritional content (usually a degradation). There is a need to preserve, measure, estimate, store and/or transmit such nutritional content information throughout the nutritional substance supply system.

The caloric and nutritional content information for a prepared food that is provided to the consumer is often minimal. For example, when sugar is listed in the ingredient list, the consumer generally does receive any information about the source of the sugar, which can come from a variety of plants, such as sugarcane, beets, or corn, which will affect its nutritional content. Conversely, some nutritional information that is provided to consumers is so detailed, the consumer can do little with it. For example, this of ingredients is from a nutritional label on a consumer product: Vitamins—A 355 IU 7%, E 0.8 mg 4%, K 0.5 mcg, 1%, Thiamin 0.6 mg 43%, Riboflavin 0.3 mg 20%, Niacin 6.0 mg 30%, B6 1.0 mg 52%, Foliate 31.5 mcg 8%, Pantothenic 7%; Minerals Calcium 11.6 1%, Iron 4.5 mg 25%, 211 mg 53%, Phosphorus 349 mg 35%, Potassium 476 mg 14%, Sodium 58.1 mg 2%, Zinc 3.7 mg 24%, Copper 0.5 mg 26%, Manganese 0.8 mg 40%, Selenium 25.7 mcg 37%; Carbohydrate 123 g, Dietary fiber 12.1 g, Saturated fat 7.9 g, Monosaturated Fat 2.1 g, Polysaturated Fat 3.6 g, Omega 3 fatty acids 108 g, Omega 6 fatty acids 3481, Ash 2.0 g and Water 17.2 g. (%=Daily Value). There is a need to provide information about nutritional substances in a meaningful manner. Such information needs to be presented in a manner that meets the specific needs of a particular consumer. For example, consumers with a medical condition, such as diabetes, would want to track specific information regarding sugar and nutrients in the foods and beverages they consume.

If fact, each silo in the food and beverage industry already creates and tracks some information, including caloric and nutritional information, about their product internally. For example, the famer who grew the corn knows the variety of the seed, condition of the soil, the source of the water, the fertilizers and pesticides used, and can measure the caloric and nutritional content at creation. The packager of the corn knows when it was picked, how it was transported to the packaging plant, how the corn was preserved and packaged before being sent to the ready-to-eat dinner producer, when it was delivered to the producer, and what degradation to caloric and nutritional content has occurred. The producer knows the source of each element of the ready-to-eat dinner, how it was processed, including the recipe followed, and how it was preserved and packaged for the consumer. Not only does such a producer know what degradation to caloric and nutritional occurred, the producer can modify its processing and post-processing preservation to minimally affect nutritional content. The preparation of the nutritional substance for consumption can also degrade the nutritional content of nutritional substances. Finally, the consumer knows how she prepared the dinner, what condiments were added, and whether she did or did not enjoy it.

If there was a mechanism to share this information, the quality of the nutritional substances, including caloric and nutritional content, could be preserved and improved. Consumers could be better informed about nutritional substances they select and consume, including the state of the nutritional substance throughout its lifecycle from creation to consumption. The efficiency and cost effectiveness of nutritional substances could also be improved. Feedback within the entire chain from creator to consumer could provide a closed-loop system that could improve quality (taste, appearance, and caloric and nutritional content), efficiency, value and profit. For example, in the milk supply chain, at least 10% of the milk produced is wasted due to safety margins included in product expiration dates. The use of more accurate tracking information, measured quality (including nutritional content) information, and historical environmental information could substantially reduce such waste. Collecting, preserving, measuring and/or tracking information about a nutritional substance in the nutritional substance supply system, would allow needed accountability. There would be nothing to hide.

As consumers are demanding more information about what they consume, they are asking for products that have higher nutritional content and more closely match good nutritional requirements, and would like nutritional products to actually meet their specific nutritional requirements. While grocery stores, restaurants, and all those who process and sell food and beverages may obtain some information from current nutritional substance tracking systems, such as labels, these current systems can provide only limited information.

Traditional food processors take nutritional substances from producers and transform them into nutritional substances for consumption by consumers. While they have some knowledge of the nutritional substances they purchase, and make such selections to meet the needs of the consumers, they generally do not transmit that information along to consumers, nor change the way they transform the nutritional substances based on the history or current condition of the nutritional substances they receive for transformation.

An important issue in the creation, preservation, transformation, conditioning, and consumption of nutritional substances are the changes that occur in nutritional substances due to a variety of internal and external factors. Because nutritional substances are composed of biological, organic, and/or chemical compounds, they are generally subject to degradation. This degradation generally reduces the nutritional, organoleptic, and/or aesthetic values of nutritional substances. While not always true, nutritional substances are best consumed at their point of creation. However, being able to consume nutritional substances at the farm, at the slaughterhouse, at the fishery, or at the food processing plant is at least inconvenient, if not impossible. Currently, the food and beverage industry attempts to minimize the loss of nutritional value (often through the use of additives or preservatives), and/or attempts to hide this loss of nutritional value from consumers.

Overall, the examples herein of some prior or related systems and their associated limitations are intended to be illustrative and not exclusive. Other limitations of existing or prior systems will become apparent to those of skill in the art upon reading the following Detailed Description.

### OBJECTS OF THE INVENTION

It is an object of the present invention to provide an information system for nutritional substance which could be accessed by both nutritional substance industry participants and non-nutritional substance entities, including consumers.

It is an object of the present invention to provide a communication system which collects, tracks, organizes information from each stage of the production of nutritional substances from creation to consumption. It is a further object of the present invention to use such information to modify the creation, packaging, transformation, conditioning and consumption of nutritional substances. It is a further object of the present invention to do so in a manner that preserves and/or enhances the nutritional value and/or taste of the nutritional substances across their lifecycle.

It is a further object of the present invention to collect, store and provide information on the consumer of the nutrition substance.

It is an object of the present invention to minimize and/or track degradation of nutritional, organoleptic, and/or aesthetic value of nutritional substances, and/or collect, store, and/or transmit information regarding this degradation.

### SUMMARY OF THE INVENTION

In an embodiment of the present invention, the transformer of nutritional substances obtains and transmits source and/or preservation information to users and/or consumers of the transformed nutritional substance.

In an embodiment of the present invention, the transformer of nutritional substances obtains and transmits source and/or preservation information to users and/or consumers of the transformed nutritional substance.

In another embodiment of the present invention, the transformer of nutritional substances obtains and transmits source and/or preservation information and information regarding the transformation to users and/or consumers of the transformed nutritional substance.

In an embodiment of the present invention, the transformer of nutritional substances obtains and transmits source and/or packaging information to users and/or consumers of the transformed nutritional substance.

In another embodiment of the present invention, the transformer of nutritional substances obtains and transmits source and/or packaging information and information regarding the transformation to users and/or consumers of the transformed nutritional substance.

In a further embodiment of the present invention, the source and/or packaging information is used by the transformer to modify the transformation of the of nutritional substances obtains and transmits source and/or packaging information to users and/or consumers of the transformed nutritional substance so as to preserve nutritional value and/or improve the quality of the transformed nutritional substance.

In another embodiment of the present invention, the source packaging information of the component nutritional substance to automatically transform the nutritional substance so as to preserve nutritional value and/or improve the quality of the transformed nutritional substance.

The an embodiment of the present invention provides a system for the creation, collection, storage, transmission, and/or processing of information regarding nutritional substances so as to improve, maintain, or minimize degradation of nutritional, organoleptic, and/or aesthetic value of nutritional substances. Additionally, the present invention provides such information for use by the creators, preservers, transformers, conditioners, and consumers of nutritional substances. The nutritional information creation, preservation, and transmission system of the present invention should allow the nutritional substance supply system to improve its ability to minimize degradation of nutritional, organoleptic and/or aesthetic value of the nutritional substance, and/or inform the consumer about such degradation. While the ultimate goal of the nutritional substance supply system is to minimize degradation of nutritional, organoleptic and/or aesthetic value, an interim goal should be providing consumers with significant information regarding degradation of nutritional substances consumers select and consume. Entities within the nutritional substance supply system who provide such information regarding nutritional substance degradation will be able to differentiate their products from those who obscure and/or hide such information. Additionally, such entities should be able to charge a premium for products which either maintain their nutritional, organoleptic, and/or aesthetic value, or supply more complete information.

Other advantages and features will become apparent from the following description and claims. It should be understood that the description and specific examples are intended for purposes of illustration only and not intended to limit the scope of the present disclosure.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale.

FIG. 1 shows a schematic functional block diagram of the nutritional substance information system of the present invention, and its interconnection to various systems; and

FIG. 2 shows a graph representing a value of a nutritional substance which changes according to a change of condition for the nutritional substance;

In the drawings, the same reference numbers and any acronyms identify elements or acts with the same or similar structure or functionality for ease of understanding and convenience. To easily identify the discussion of any particular element or act, the most significant digit or digits in a reference number refer to the Figure number in which that element is first introduced.

### DETAILED DESCRIPTION OF THE INVENTION

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other obvious features not described in detail herein. Additionally, some well-known structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

The following discussion provides a brief, general description of a representative environment in which the invention can be implemented. Although not required, aspects of the invention may be described below in the general context of computer-executable instructions, such as routines executed by a general-purpose data processing device (e.g., a server computer or a personal computer). Those skilled in the relevant art will appreciate that the invention can be practiced with other communications, data processing, or computer system configurations, including: wireless devices, Internet appliances, hand-held devices (including personal digital assistants (PDAs)), wearable computers, all manner of cellular or mobile phones, multi-processor systems, microprocessor-based or programmable consumer electronics, set-top boxes, network PCs, mini-computers, mainframe computers, and the like. Indeed, the terms “controller,” “computer,” “server,” and the like are used interchangeably herein, and may refer to any of the above devices and systems.

While aspects of the invention, such as certain functions, are described as being performed exclusively on a single device, the invention can also be practiced in distributed environments where functions or modules are shared among disparate processing devices. The disparate processing devices are linked through a communications network, such as a Local Area Network (LAN), Wide Area Network (WAN), or the Internet. In a distributed computing environment, program modules may be located in both local and remote memory storage devices.

Aspects of the invention may be stored or distributed on tangible computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data related to the invention may be distributed over the Internet or over other networks (including wireless networks), on a propagated signal on a propagation medium (e.g., an electromagnetic wave(s), a sound wave, etc.) over a period of time. In some implementations, the data may be provided on any analog or digital network (packet switched, circuit switched, or other scheme).

In some instances, the interconnection between modules is the internet, allowing the modules (with, for example, WiFi capability) to access web content offered through various web servers. The network may be any type of cellular, IP-based or converged telecommunications network, including but not limited to Global System for Mobile Communications (GSM), Time Division Multiple Access (TDMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), Worldwide Interoperability for Microwave Access (WiMAX), Universal Mobile Telecommunications System (UMTS), Evolution-Data Optimized (EVDO), Long Term Evolution (LTE), Ultra Mobile Broadband (UMB), Voice over Internet Protocol (VoIP), Unlicensed Mobile Access (UMA), etc.

The organizations, industries and systems connected to nutritional substance information systems 100 can be understood to be integrated in some instances and in particular embodiments, only particular systems may be interconnected.

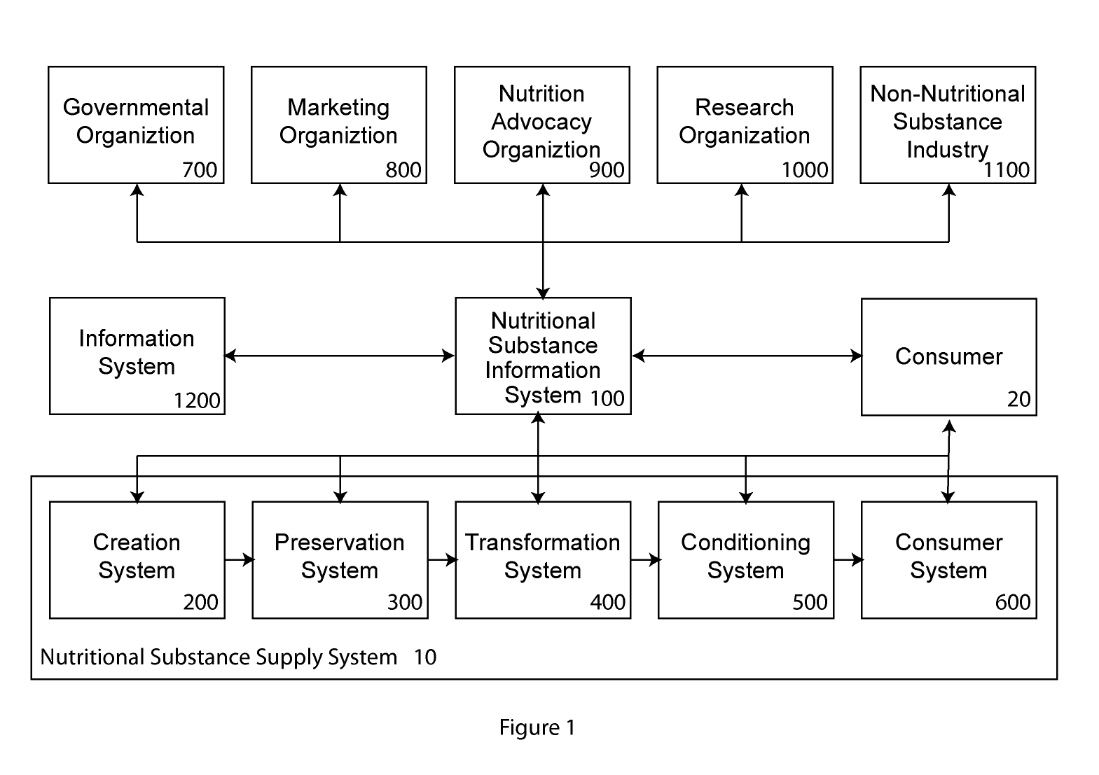

FIG. 1 shows the components of a nutritional substance industry 10. It should be understood that this could be the food and beverage and beverage ecosystem for human consumption, but could also be the feed industry for animal consumption, such as the pet food industry. A goal of the present invention for nutritional substance industry 10 is to create, preserve, transform and trace the qualitative, organoleptic and nutritional properties of nutritional substances through their creation, preservation, transformation, conditioning and consumption. While the nutritional substance industry 10 can be composed of many companies or businesses, it can also be integrated into combinations of business serving many roles, or can be one business or even individual.

Module 200 is the creation module. This can be system, organization, or individual which creates and/or originates nutritional substances. Examples of this module include a farm which grows produce. It can be a ranch which raises beef. It can be an aquaculture far for growing shrimp. It could be a factory with synthesizes nutritional compounds. It could be collector of wild truffles. If could be a deep sea crab trawler.

Preservation module 300 is a preservation system for preserving and protecting the nutritional substances created by creation module 200. Once the nutritional substance has been created, generally, it will need to be packaged in some manner for its transition to other modules in the nutritional substances industry 10. While preservation module 300 is shown in a particular position in the nutritional substance industry 10, following the creation module 200, it should be understood that the preservation module 300 actual can be placed anywhere nutritional substances need to be preserved during their transition from creation to consumption.

Transformation module 400 is a nutritional substance processing system, such as a manufacturer who processes raw materials such as grains into breakfast cereals. Transformation module 400 could also be a ready-to-eat dinner manufacturer who receives the components for a ready-to-eat dinner from preservation module 300 and prepares them into a frozen dinner. While transformation module 400 is depicted as one module, it will be understood that nutritional substances may be transformed by a number of transformation modules 400 on their path to consumption.

Conditioning module 500 is a consumer preparation system for preparing the nutritional substance immediately before consumption by the consumer. Conditioning module 500 can be a microwave oven, a blender, a toaster, a convection oven, a cook, etc. It can also be systems used by commercial establishments to prepare nutritional substance for consumers such as a restaurant, an espresso maker, pizza oven, and other devices located at businesses which provide nutritional substances to consumers. Such nutritional substances could be for consumption at the business or for the consumer to take out from the business. Conditioning module 500 can also be a combination of any of these devices used to prepare nutritional substances for consumption by consumers.

Consumer module 600 collects information from the living entity which consumes the nutritional substance which has passed through the various modules from creation to consumption. The consumer can be a human being, but could also be an animal, such as pets, zoo animals and livestock, which are they themselves nutritional substances for other consumption chains. Consumers could also be plant life which consumes nutritional substances to grow.

Information module 100 receives and transmits information regarding a nutritional substance between each of the modules in the nutritional substance industry 10 including, the creation module 200, the preservation module 300, the transformation module 400, the conditioning module 500, and the consumer module 600. The nutritional substance information module 100 can be an interconnecting information transmission system which allows the transmission of information between various modules. Information module 100 contains a database where the information regarding the nutritional substance resides. Information module 100 can be connected to the other modules by a variety of communication systems, such as paper, computer networks, the internet and telecommunication systems, such as wireless telecommunication systems.

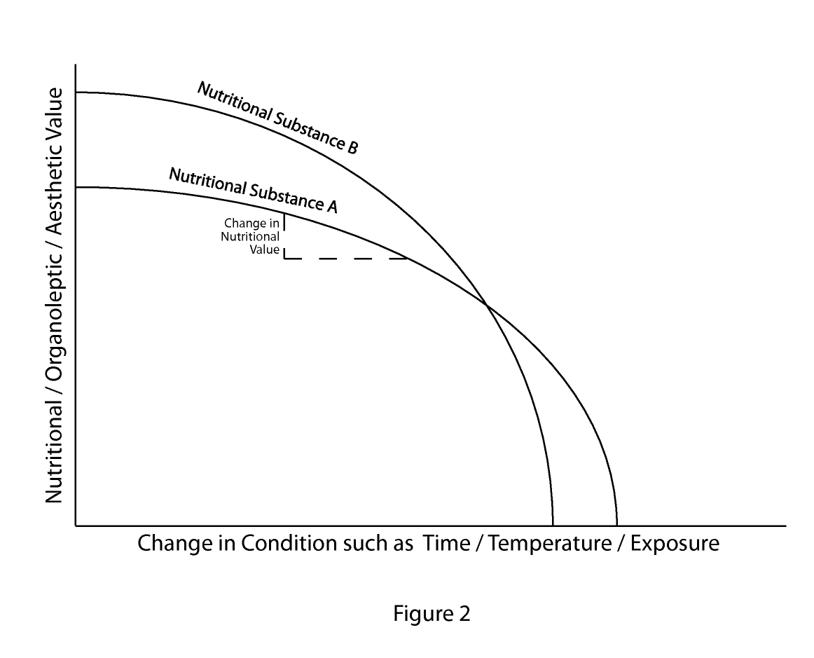

FIG. 2 is a graph showing the function of how a value of a nutritional substance varies over the change in a condition of the nutritional substance. Plotted on the vertical axis of this graph can be either the nutritional value, organoleptic value, or even the aesthetic value of a nutritional substance. Plotted on the horizontal axis can be the change in condition of nutritional substance over a variable such as time, temperature, location, and/or exposure to environmental conditions. This exposure to environmental conditions can include exposure to air, including oxygen, exposure to moisture, exposure to radiation such as heat or sunlight, or exposure to materials such as packaging. The function plotted as nutritional substance A could show the degradation of in the nutritional value of milk over time. Any point on this curve can be compared to another point to measure and/or describe the change in nutritional value. The plot of the degradation in nutritional value of nutritional substance B describes a nutritional substance which starts out with a higher nutritional value than nutritional substance A, but degrades over time more quickly than nutritional substance A.

If, in this example, where nutritional substance A and nutritional substance B are milk, this information regarding the nutritional substance degradation profile of each milk could be used by the consumer in the selection and/or consumption of the milk. If the consumer has this information at time zero when selecting a milk product for purchase, the consumer could consider when the consumer plans to consume the milk, whether that is on one occasion or multiple occasions. For example, if the consumer planned to consume the milk prior to the point when the curve represented by nutritional substance B crosses the curve represented by nutritional substance A, then the consumer should choose the milk represented by nutritional substance B because it has a higher nutritional value until it crosses the curve represented by nutritional substance A. However, if the consumer expects to consume at least some of the milk at a point in time after the time when the curve represented by nutritional substance B crosses the curve represented by nutritional substance A, then the consumer might choose to select the milk represented by the nutritional substance A, even though milk represented by nutritional substance A has a lower nutritional value than the milk represented by nutritional substance B at an earlier time. This change to a desired value in a nutritional substance over a change in the nutritional substance described in FIG. 2 can be measured and/or controlled throughout nutritional substance supply system 10 in FIG. 1.

In FIG. 1, Creation module 200 can dynamically encode nutritional substances to enable the tracking of nutritional, organoleptic, and/or aesthetic value of the nutritional substance. This dynamic encoding can replace and/or complement existing nutritional substance marking systems such as barcodes, labels, and/or ink markings. This dynamic encoding can be used to make nutritional substance information from creation module 200 available to information module 100 for use by preservation module 300, transformation module 400, conditioning module 500, and/or consumption module 600, which includes the ultimate consumer of the nutritional substance. One method of marking the nutritional substance by creation module 200 (or actually any other module in nutritional supply system 10) could include an electronic tagging system, such as the tagging system manufactured by Kovio of San Jose, Calif., USA. Such thin film chips can be used not only for tracking nutritional substances, by can include components to measure attributes of nutritional substances, and record and transmit such information. Such information may be readable by a reader including a satellite-based system. Such a satellite-based nutritional substance information tracking system could comprise a network of satellites with coverage of some or all the surface of the earth, so as to allow information module 100 real time, near real time updates about a particular nutritional substance.

Preservation module 300 includes packers and shippers of nutritional substances. The tracking of nutritional, organoleptic, and/or aesthetic values during the preservation period within preservation module 300 allows for dynamic expiration dates for nutritional substances. For example, expiration dates for dairy products are currently based generally only on time using assumptions regarding minimal conditions at which dairy products are maintained. This extrapolated expiration date is based on a worst-case scenario for when the product becomes unsafe to consume during the preservation period. In reality, the degradation of dairy products may be significantly less than this worst-case. If preservation module 300 could measure or derive the actual degradation information, the actual expiration date could be significantly later in time. This would allow the nutritional substance supply system to dispose of fewer products due to expiration dates. This ability to dynamically generate expiration dates for nutritional substances is of particular significance when nutritional substances contain few or no preservatives. Such products are highly valued throughout nutritional substance supply system 10, including consumers who are willing to pay a premium for nutritional substances with few or no preservatives.

By law, in many localities, food processors such as those in transformation module 400 are required to provide nutritional substance information regarding their products. Often, this information takes the form of a nutritional table applied to the packaging of the nutritional substance. Currently, the information in this nutritional table is based on averages or minimums for their typical product. Using the nutritional substance information from information module 100 provided by creation module 200, preservation module 300, and/or information from the transformation of the nutritional substance by transformation module 400, the food processor could include a nutritional table for the actual nutritional substance being supplied. The information in such a dynamically generated nutritional table could be used by conditioning module 500 in the preparation of the nutritional substance, and/or used by consumption module 600, so as to allow the ultimate consumer the ability to select the most desirable nutritional substance which meets their needs, and/or to track information regarding nutritional substances consumed.

The change in nutritional, organoleptic, and/or aesthetic value by conditioning module 500 is currently not tracked or provided to the consumer. However, using information provided by information module 100 from creation module 200, preservation module 300, transformation module 400, and/or information measured or generated by conditioning module 500, conditioning module 500 could provide consumer with the actual, and/or estimated change in nutritional, organoleptic, and/or aesthetic values of the nutritional substance. Such information regarding the change to nutritional, organoleptic and/or aesthetic value of the nutritional substance could be provided not only to the consumer, but could also be provided to information module 100 for use by creation module 200, preservation module 300, transformation module 400, so as to track, and possibly improve nutritional substances throughout the entire nutritional substance supply system 10.

The information regarding nutritional substances provided by information module 100 to consumption module 600 can replace or complement existing information sources such as recipe books, food databases like www.epicurious.com, and Epicurious apps. Through the use of specific information regarding a nutritional substance from information module 100, consumers can use consumption module 600 to select nutritional substances according to nutritional, organoleptic, and/or aesthetic values. This will allow consumers to make informed decisions regarding nutritional substance additives, preservatives, genetic modifications, origins, traceability, and other nutritional substance attributes. This information can be provided by consumption module 600 through personal computers, laptop computers, tablet computers, and/or smartphones. Software running on these devices can include dedicated computer programs, modules within general programs, and/or smartphone apps. An example of such a smartphone app regarding nutritional substances is the iOS ShopNoGMO from the Institute for Responsible Technology. This iPhone app allows consumers access to information regarding non-genetically modified organisms they may select. Additionally, consumption module 600 may provide information for the consumer to operate conditioning module 500 in such a manner as to preserve nutritional, organoleptic, and/or aesthetic value.

Through the use of nutritional substance information available from information module 100 nutritional substance supply system 10 can track nutritional, organoleptic, and/or aesthetic value. Using this information, nutritional substances travelling through nutritional substance supply system 10 can be dynamically valued and priced according to nutritional, organoleptic, and/or aesthetic values. For example, nutritional substances with longer expiration dates (longer shelf life) may be more highly valued than nutritional substances with shorter expiration dates. Additionally, nutritional substances with higher nutritional, organoleptic, and/or aesthetic values may be more highly valued, not just by the consumer, but also by each entity within nutritional substance supply system 10. This is because each entity will want to start with a nutritional substance with higher nutritional, organoleptic, and/or aesthetic value before it performs its function and passes the nutritional substance along to the next entity.

During the period of implementation of the present inventions, there will be nutritional substances being marketed which including the information, information-enabled nutritional substances, and nutritional substances which are not information enabled, dumb nutritional substances. Information-enabled nutritional substances would be available in virtual internet marketplaces, as well as traditional marketplaces. Because of information provided by information-enabled nutritional substances, entities within the nutritional substance supply system 10, including consumers, would be able to review and select information-enabled nutritional substances for purchase. It should be expected that, initially, the information-enabled nutritional substances would enjoy a higher market value and price than dumb nutritional substances. However, as information-enabled nutritional substances become more the norm, the cost savings from less waste due to degradation of information-enabled nutritional substances could lead to their price actually becoming less than dumb nutritional substances.

For example, the producer of a ready-to-eat dinner would prefer to use corn of a high nutritional, organoleptic, and/or aesthetic value in the production of its product, the ready-to-eat dinner, so as to produce a premium product of high nutritional, organoleptic, and/or aesthetic value. Depending upon the levels of the nutritional, organoleptic, and/or aesthetic values, the ready-to-eat dinner producer may be able to charge a premium price and/or differentiate its product from that of other producers. When selecting the corn to be used in the ready-to-eat dinner, the producer will seek corn of high nutritional, organoleptic, and/or aesthetic value from preservation module 300 that meets its requirements for nutritional, organoleptic, and/or aesthetic value. The packager/shipper of preservation module 300 would also be able to charge a premium for corn which has high nutritional, organoleptic, and/or aesthetic values. And finally, the packager/shipper of preservation module 300 will select corn of high nutritional, organoleptic, and/or aesthetic value from the grower of creation module 200, who will also be able to charge a premium for corn of high nutritional, organoleptic, and/or aesthetic values.

The nutritional, organoleptic, and/or aesthetic value for a nutritional substance tracked through nutritional substance supply system 10 through nutritional substance information from information module 100 can be preferably measured information. However, some or all such nutritional substance information may be derived through measurements of environmental conditions of the nutritional substance as it travelled through nutritional substance supply system 10. Additionally, some or all of nutritional substance information can be derived from data of other nutritional substances which have travelled through nutritional substance supply system 10. Finally, nutritional substance information can also be derived from laboratory experiments performed on other nutritional substances, which may approximate conditions and/or processes to which the actual nutritional substance has been exposed.

For example, laboratory experiments can be performed on bananas to determine effect on nutritional, organoleptic, and/or aesthetic value for a variety of environmental conditions bananas may be exposed to during packaging and shipment in preservation module 300. Using this experimental data, tables and/or algorithms could be developed which would predict the level of nutritional, organoleptic, and/or aesthetic values for a particular banana based upon information collected regarding the environmental conditions to which the banana was exposed during its time in preservation module 300. While the ultimate goal for nutritional substance supply system 10 would be the actual measurement of nutritional, organoleptic, and/or aesthetic values, use of derived nutritional, organoleptic, and/or aesthetic value from experimental information would allow more accurate tracking of nutritional, organoleptic, and/or aesthetic values while technology and systems are put in place to allow actual measurement.

In FIG. 1, all the systems comprising nutritional substance supply system 10, including creation system 200, preservation system 300, transformation system 400, conditioning system 500, and consumer system 600, that are operably connected to nutritional substance information system 100 can additionally receive information from, and/or provide information to, governmental organization 700, marketing organization 800, nutrition advocacy organization 900, research organization 1000, non-nutritional substance industry 1100, information system 1200, and consumer 20 through nutritional substance information system 100.

Nutritional substance information system 100 receives and transmits information regarding a nutritional substance between each of the systems in the nutritional substance industry 10 including, the creation system 200, the preservation system 300, the transformation system 400, the conditioning system 500, and the consumer system 600. The nutritional substance information system 100 can be an interconnecting information transmission system which allows the transmission of information between some or all of the various systems. Nutritional substance information system 100 contains a database where the information regarding the nutritional substance resides.

Nutritional substance information system 100 is operably connected to at least one of the following systems: creation system 200, preservation system 300, transformation system 400, conditioning system 500, and consumer system 600. Each system collects information from its associated tasks regarding a nutritional substance and provides such information to nutritional substance information system 100. Additionally, nutritional substance information system 100 can provide such collected information to the other systems, as well as outside parties not part of nutritional substance industry 10

Creation system 200 collects information regarding a particular nutritional substance, such as information regarding the genesis of the nutritional substance, information regarding the growing or raising of the nutritional substance, information regarding the harvesting or slaughtering of the nutritional substance, and where the nutritional substance was delivered. This creation information can be delivered by creation system 200 to nutritional substance information system 100 by means of a communications network such as a telecommunications network and, preferably, a wireless telecommunications network.

For example, if the nutritional substance is corn, the farmer would collect information regarding the seed that was planted, the location and soil the seed was planted in, the water used for irrigation, and any fertilizers or pesticides used in growing the corn. Additionally, creation information as to when the corn was planted and when it was harvested and to whom the corn was delivered could also be collected. In the case of a wine maker the state of the soil the weather during the growing period of the vines, the state of ripeness at recollection and the description of the “torroir” land composition, inclination, weather conditions, fermentation and bottling techniques, etc. could all be incorporated. The farmer would provide such information to nutritional substance information system 100 and eventually the information could be automatically downloaded and monitored trough a telecommunications network and, preferably, a wireless telecommunications and or satellite network. This would be a significant contribution to discourage counterfeiting/tampering and increase the value of authentic natural ingredients. Additionally, it would serve as a tool to prevent identify epidemic outbreaks and control them early on at its origin.

In the case where nutritional substance is beef hamburger meet, the rancher would collect information regarding the lineage of the cow, where the cow was raised (open range, feed yard, etc.), what the cow was fed, the medical history of the cow, and what dietary supplements and drugs were given to the cow. The rancher would also collect information regarding the cow's date of birth and when the cow was sold or slaughtered. All such creation information would be provided by the rancher to nutritional substance information system 100.

Preservation system 300 preserves nutritional substance during its journey from the creation system 200 to the transformation system 400. However, it is understood that preservation system 300 may be located between any two systems for the transfer of nutritional substance between those systems. For example, not only does the nutritional substance need to be preserved between creation system 200 and transformation system 400, it also needs to be preserved between transformation system 400 and conditioning system 500. Preservation system 300 obtains creation information regarding the nutritional substance from nutritional substance information system 100. Using that information, preservation system 300 optimizes the preservation of the nutritional substance so as to preserve or improve the organoleptic and nutritional properties of the nutritional substance.

Additionally, preservation system 300 provides information to nutritional substance information system 100 regarding the nutritional substance during the time it is being preserved and shipped to transformation system 400. This information could include the condition of the nutritional substance when it was received for preservation, the condition of the nutritional substance during its preservation, and the condition of the nutritional substance at the end of its preservation. Additionally, such preservation information could include the environmental conditions outside the preservation system 300 during the period of preservation and shipment. Preservation system 300 could also provide information regarding the interior conditions of preservation system 300 during the preservation and shipment of the nutritional substance. Finally, if preservation system 300 dynamically modified its preservation of the nutritional substance during its preservation and shipment, information regarding how preservation system 300 dynamically modified itself during the period of preservation and shipment could be provided to nutritional substance information system 100.

In the case where the nutritional substance is bananas, preservation 300 could provide to nutritional substance information system 100 information about the current state of the bananas, as well as the exterior and interior conditions of preservation system 300, as well modifications preservation system 300 made to itself to ripen the bananas during preservation so as to meet optimize organoleptic and nutritional properties when the bananas arrive at the grocery store.

In the case where the nutritional substance is beef which is being aged during the period it is preserved by preservation system 300, preservation system 300 could provide nutritional substance information system 100 with information regarding the condition of the beef from the time of its delivery to preservation system 300, through the time the beef was preserved by preservation system 300, to when it was removed from preservation system 300. This preservation information provided to nutritional substance information system 100 could be used by the conditioner of the beef, such as a restaurant, to determine how to properly cook the beef.

Transformation system 400 could retrieve from nutritional substance information system 100 both creation information provided by creation system 200 and preservation information provided by preservation system 300. Transformation system 400 could use such creation information and preservation information to dynamically modify the transformation of the nutritional substance. Additionally, transformation system 400 could provide nutritional substance information system 100 with transformation information.

In the case where the nutritional substance is sweet corn which is to be cooked and canned for consumer consumption, transformation system 400 could use the creation information regarding the composition of the corn, including its nutrients and additives, to determine how to transform the corn so as to preserve or improve organoleptic and nutritional properties. Transformation system 400 could also use preservation information regarding the corn to modify the transformation in response to changes to the corn which occurred during preservation. The information regarding how the corn was transformed in transformation system 400, such as cooking temperatures and duration and substances added to the canned corn, could be provided by transformation system 400 to nutritional substance information system 100.

Conditioning system 500 receives information regarding the nutritional substance from nutritional substance information system 100. This information could include creation information provided by creation system 200, preservation information provided by preservation system 300, and transformation information from transformation system 400. Additionally, conditioning system 500 could receive recipe information from nutritional substance information system 100. All such information could be used by conditioning system 500 in the conditioning of the nutritional substance. Conditioning system 500 can provide nutritional substance information system 100 with conditioning information regarding how the nutritional substance was conditioned, as well as measured or sensed information as to the state of the nutritional substance before, during and upon completion of conditioning.

In the example of a frozen ready-to-eat dinner, conditioning system 500 could use such information provided by nutritional substance information system 100 to optimize the conditioning of the nutritional substance by conditioning system 500. Conditioning system 500 could dynamically modify the conditioning of the nutritional substance in response to information it receives from nutritional substance information system 100 regarding the organoleptic and nutritional properties of the nutritional substance. Conditioning system 500 could use information about the corn and beef in the dinner to modify the defrosting and cooking the dinner.

Consumer system 600 obtains consumer information from the consumer of the nutritional substance. Such consumer information could include feedback from the consumer as to the quality and taste of the nutritional substance. Consumer system 600 provides such information to nutritional substance information system 100. Nutritional substance information system 100 correlates this information with all the information provided regarding the nutritional substance and provides some or all consumer information to the various systems in nutritional substance supply system 10. Each system in the nutritional substance supply system 10 could use such consumer information to modify and/or improve its operation. Additionally, consumer system 600 could obtain information from the consumer as to the effectiveness of the marketing of the nutritional substance consumed. This information can also be provided to others for general consumer satisfaction information for other purposes, such as development of new nutritional substances, modification of existing nutritional substances, discontinuation of nutritional substances, and/or marketing of nutritional substances.

It should be understood that nutritional substances do not need to necessarily pass through all the systems in nutritional substance supply system 10. For example, produce grown and sold to a consumer at the farm would only pass through creation system 200 and consumer system 600. Bananas grown on a plantation and shipped to a grocery store may only pass through creation system 200 and preservation system 300 before being consumed by consumer in consumer system 600. In the case where the nutritional substance is Brussels sprouts, the Brussels sprouts would have creation information provided by creation system 200, preservation information from preservation system 300, and conditioning information from conditioning system 500 before being delivered to consumer system 600.

In the case where the nutritional substance can be consumed following transformation by transformation system 400 without the need for conditioning by conditioning system 500, the nutritional substance would pass directly from transformation system 400 to consumer system 600. In the case of dried cranberries, creation information from creation system 200, the cranberry grower, would be provided to nutritional substance information system 100. Preservation information from preservation system 300 would be provided to nutritional substance information system regarding the preservation of the cranberries during their trip from the cranberry grower to transformation system 400, the dried fruit processor. Transformation information regarding the drying of the cranberries by transformation system 400 would be provided to nutritional substance information system 100. An additional preservation system 300 would preserve the dried cranberries during their trip from the dried fruit processor to the consumer in consumer system 600. In this case, there would be no conditioning system 500 in nutritional substance supply system 10, as the dried cranberries do not necessarily need to be conditioned before consumption.

It will also be understood that nutritional substances may pass through nutritional substance supply system 10 more than one time. In the case of the nutritional substance being wheat flour which is eventually used to make bread, the wheat grain may pass through conditioning system 200, preservation system 300, and transformation system 400 to become wheat flour. The flour can then be passed to a preservation system 300 for delivery to a transformation system 400 which prepares bread dough, for conditioning in a conditioning system 500, which bakes the dough into bread for consumer system 600. During the wheat's multiple trips through nutritional substance supply system 10, nutritional substance information system 100 receives and provides information regarding the wheat.

It will be additionally understood that for certain complex nutritional substances such as a frozen ready-to-eat dinner, a plurality of nutritional substances may travel through nutritional substance supply system 10 to be transformed by transformation system 400 into the complete ready-to-eat dinner which is eventually conditioned by conditioning system 500. The plurality of nutritional substances used to form the ready-to-eat dinner would each be tracked through nutritional substance supply system 10, where nutritional substance information system 100 receives and provides information regarding the component nutritional substances used in the ready-to-eat dinner.

Nutritional substance information system 100 can be implemented as a computer hosted database such as a flat database, or a relational database. Preferably, nutritional substance information system 100 is a multi-dimensional database.

Nutritional substance information system 100 may also contain information regarding the consumer of the nutritional substance. This information could include the consumer's medical history, current physical condition, including height, weight and BMI. Additional consumer information could include specific dietary needs, such as vitamin and mineral levels and food allergies. Additional consumer information could include food preferences, such as disliking cilantro or preferring well-cooked meat, or al dente pasta. Dietary preferences could also include whether the consumer is vegetarian, vegan, kosher, macrobiotic, gluten free, etc. Additional consumer information could include current dietary programs such as being on a diet, such as the South Beach diet, the Atkins diet, the Weight Watchers diet, or a diet provided by the consumer's physician.

Nutritional substance information system 100 could track the nutritional substances consumed to track and manage the diets of consumers. For example, a consumer who is diabetic, allergic to gluten or on dialysis must manage the levels of certain chemicals in their blood for the dialysis to be effective. Nutritional substance information system 100 could track such information regarding nutritional substances being consumed. Additionally, nutritional substance information system 100 could provide information to consumer system 600 to assist in nutritional substance selection, including menu planning. This could include not only suggestions as to nutritional substances to be consumed, but also nutritional substances that should not be consumed. Further, such information from nutritional substance information system 100 could allow consumer system 600 to suggest compromises in the selection of nutritional substances.

Nutritional substance information system 100 is preferably implemented as a global massive, multidimensional database operated on multiple computing devices across an interconnecting network. Such a database could be hosted by a plurality of nutritional substance creators, preservers, transformers, conditioners, consumers. Preferably, nutritional substance information system 100 is maintained and operated by a global entity which operates the system for the benefit of all participants in the nutritional substance supply system 10. In such an nutritional substance information system 10, the global entity could be remunerated on a per-transaction basis for receiving nutritional substance information and/or providing nutritional substance information, trough-out its lifecycle form its origin to consumption and could be monitored traced through a data base and or real time tough a satellite system.

In another business model for the global entity operating nutritional substance information system 100, access to the system by participants in the supply chain could be at no charge. However, the global entity could receive remuneration for access by non-participants such as research and marketing organizations. Alternatively, participants in the supply chain could pay to advertise to other participants in the supply chain as part of their access to the information in nutritional substance information system 100.

Information transfer throughout nutritional substance supply system 10, to and from nutritional substance information system 100 can be accomplished through various computer information transmission systems, such as the internet. Such interconnection could be accomplished by wired networks and wireless networks, or some combination thereof. Wireless networks could include WiFi local area networks, Bluetooth networks, but preferably wireless telecommunication networks.

Nutritional substance information system 100 can also be operably connected to consumer 20. Consumer 20 can be an individual, a collection of individuals, or an organization of individuals. If consumer 20 is an individual, consumer 20 could provide information to nutritional substance information system 100 by means of manual entry through a computer interface. Preferably the information could be provided by automatic data collection from consumer's 20 consumption, preparation, feedback, biometric data, or medical assessment. Consumer 20 can utilize information stored in nutritional substance information system 100 through a computer interface. Preferably, consumer 20 could utilize information from nutritional substance information system 100 in automated fashion through selection of nutritional substances to be consumed, preparation of nutritional substances, including creation, preservation, transformation, and conditioning.

For example, consumer 20 could provide biometric (such as BMI) and medical information along with consumption information to nutritional substance information system 100. Such information could be correlated so as to provide consumer 20, information on selection and preparation of future nutritional substances to be consumed by consumer, to minimize or maximize the organoleptic and/or nutritional properties of selected nutritional substances. In the circumstance of consumer 20 being diabetic, as indicated by consumer's 20 biometric and medical information, nutritional substance information system 100 could provide nutritional substance suggestions and/or nutritional substance preparation techniques so as to provide a nutritional substance diet which is non-detrimental, and is advantageous for such a medical condition. Additionally, if consumer 20 has provided nutritional substance information system 100 with nutritional substance preferences and/or nutritional substance preparation preferences, nutritional substance information system 100 can suggest nutritional substance selection choices and nutritional substance preparation choices which could encourage consumer 20 to consume non-detrimental or advantageous nutritional substances. Additionally, if consumer 20 would provide biometric information prior to and following consumption of a nutritional substance, such as blood sugar level information, nutritional substance information system 100 could record and correlate such information for use in future nutritional substance selection and preparation.

Preferably, nutritional substance information system 100 could receive such consumer information from a plurality of consumers. Nutritional substance information system 100 could analyze and correlate such information for consumers to identify trends, techniques, and/or classes of nutritional substances or nutritional substance preparation techniques which might benefit consumer 20. For example, nutritional substance information system 100, in analyzing information from a plurality of consumers 20, could determine that individuals with diabetes would benefit from a diet high in whole grain cereals. Nutritional substance information system 100 would then suggest to a consumer 20 who fits in the group of such diabetic consumers 20 a diet high in whole grain cereals.

Consumer 20 can also be operably connected to consumer system 600. Consumer 20 can receive nutritional substances from consumer system 600, located within nutritional substance supply system 10. Consumer 20 can receive information regarding the nutritional substance from consumer system 600, and provide feedback regarding the nutritional substance to consumer system 600. Consumer system 600 can provide such feedback, consumer information, to nutritional substance information system 100 correlated to the nutritional substance provided to consumer 20.

Governmental organization 700 could provide to nutritional substance information system 100 a variety of information collected by governmental organizations. This could include any of the following information: information regarding location of nutritional substance creation, environmental information about the location of nutritional substance creation, including weather, geographic information on nutritional substance preservation and transformation, geo-political, socio-economic, and industry economic information on nutritional substances created, preserved, transformed, conditioned and consumed within the governmental organization's geographic area. Governments routinely collect this information for governmental and non-governmental purposes. Some of such information may already be correlated for use in nutritional substance information system 100, but any such non-correlated information could be correlated and analyzed by nutritional substance information system 100.

For example, the government of Columbia collects and tracks information about its country, including information specific to nutritional substances created, preserved, transformed, conditioned and consumed within and outside the country of Columbia. Additionally, the government of Columbia collects and tracks information regarding geographic uses of its land and resources, geological and meteorological information, information regarding the political and economic conditions within its boundaries, and information regarding industries within its boundaries. In a specific example, Columbia collects and tracks information regarding its coffee bean industry, including information on growers, processors, and distributors of coffee beans within its boundaries. Additionally, Columbia collects and tracks information on the national and international coffee bean industry. The government of Columbia could provide such information to nutritional substance information system 100.

Governmental organization 700 could receive information from nutritional substance information system 100. In the example of the government of Columbia, the government could use such information regarding the use of nutritional substance to plan and manage public health and assist in developing and promoting socio-economic systems, including specific nutritional substance industries. In the coffee bean example, the government of Columbia could predict worldwide trends in coffee consumption and assist its coffee bean industry in meeting those needs to maximize the country's economic goals.

Marketing organization 800 can provide nutritional substance information system 100 with information regarding the various markets for nutritional substances, including both current and historic data on such markets. Additionally, marketing organization 800 could provide information on past, present and future marketing campaigns and programs. In the case of coffee beans marketing organization 800 could provide information on the worldwide coffee market, including information on consumption, historical demand, and/or projected future demand of various varieties of coffee beans on a worldwide, regional, and/or local basis. Marketing organization 800 could also provide information on various marketing campaigns and strategies related to coffee beans. Also, future marketing campaigns, programs and/or strategies could be provided to nutritional substance information system 100. Specifically, marketing organization 800 could provide information on the consumption of Columbian grown coffee beans in the United States, information on prior marketing efforts of Columbian grown coffee beans in the United States, and, finally, a proposed program for such marketing in the future.

Marketing organization 800 could receive from nutritional substance information system 100, information on historical, current, and projected consumption of a nutritional substance, as well as factors influencing the growing, preservation, transformation, conditioning, and consumption of the nutritional substance on a global, regional, and/or local basis. Marketing organization 800 could also receive information on the effectiveness of various marketing campaigns, programs and/or strategies implemented by marketing organization 800. This information could be obtained from the various other sources in the network of systems, organizations, and consumers connected to nutritional substance information system 100.

In the example of Columbian coffee beans, marketing organization 800 could receive information on the consumption of Columbian coffee, and consumer marketing research on the effectiveness of prior and current marketing efforts for Columbian coffee beans. Nutritional substance information system 100 could correlate and analyze consumption information in the United States over the period and following the Columbian coffee grower's campaign using the fictional character Juan Valdez.

Nutritional advocacy organization 900 provides nutritional substance information system 100 with information regarding past goals and objectives, current goals and objectives, and contemplated future goals and objectives for individual, group, worldwide consumers of nutritional substances. These goals and objectives could include means for meeting organoleptic and/or nutritional parameters for an individual, group, worldwide consumers. Additionally, such goals and objectives could include nutritional substance sustainability, ecosystem stability, socioeconomic stability, and/or political stability.

For example, a nutritional advocacy organization 900 has goals and objectives regarding reducing the amount of fat in the American diet. Nutritional advocacy organization 900 could provide such a goal of reducing fat to nutritional substance information system 100. Nutritional substance information system 100 could provide such a goal to other organizations, industries, information systems and the nutritional substance supply system 10. Nutritional substance supply system 10 could use such information to modify the creation, preservation, transformation and conditioning of nutritional substances to assist in meeting the goal of reducing fat in the American diet. Consumer system 600 could receive feedback from consumer 20 on the effect of meeting such a goal from nutritional advocacy organization 900. For example, consumer system 600 could provide information on whether consumer 20 is selecting and consuming low-fat nutritional substances and their satisfaction/dissatisfaction with such nutritional substances.

Nutritional advocacy organization 900 could receive from nutritional substance information system 100, information regarding the success or failure in meeting nutritional advocacy organization' 900 goals and objectives. In the reducing fat in the American diet example, nutritional advocacy organization 900 could receive information from the nutritional substance supply system 10 as to any changes in the creation, preservation, transformation, condition and consumption of low-fat nutritional substances for the American market. It could also receive information from consumer 20, as to consumer's 20 consumption of such low-fat nutritional substances. From this information provided by nutritional substance information system 100, nutritional advocacy organizations could gauge the effectiveness of their campaign to reduce fat in the American diet. Using this information, nutritional advocacy organization 900 could continue, modify, or discontinue this program, and/or plan future programs.

Research organization 1000 could provide information to nutritional substance information system 100 regarding research they have conducted on nutritional substances, consumers, geography, logistics, consumption, socio-economics, politics, ecology, and their interconnection. Such research organization 1000 could include “think tank” research organizations, industry organizations, consumer organizations, marketing research organizations, educational institutions, and governmental research organizations. Research organization 1000 could include both nutritional substance related research organizations and non-nutritional substance research organizations. For example, the University of California at Davis has an extensive research organization into the creation, preservation, transformation, conditioning of grapes and wine. UC Davis could provide such information to nutritional substance information system 100, which could correlate such research information with information regarding grapes and wine provided by creation system 200, preservation system 300, transformation system 400, conditioning system 500, consumer system 600, and consumer 20.

Research organization 1000 can receive from nutritional substance information system 100 information related to the research conducted by research organization 1000. For example, UC Davis could receive information from nutritional substance supply system 10 and consumer 20 to use in its collection and analysis of research it is conducting regarding the grape and wine industry.

Non-nutritional substance industry 1100 could provide nutritional substance information system 100 with information not related to nutritional substances, but useful in analyzing and utilizing information related to nutritional substances. For example, the housing industry could provide information as to where homes have been built, are being built, and are being planned for future construction. This information can be correlated by nutritional substance information system 100 and used by nutritional substance supply system 10 to plan where nutritional substances should be created, how nutritional substances should be preserved for shipment to such homes, how nutritional substances should be transformed for consumption in such homes, what conditioning systems should be located within such homes, and how consumer information should be collected by consumer system 600 in such homes.

Non-nutritional substance industry 1100 could receive information from nutritional substance information system 100 from information from nutritional substance supply system 10 to manage and plan non-nutritional substance industry 1100 factors affected by nutritional substance supply system 10. For example, in the housing industry, home locations and designs could be affected by information regarding where nutritional substances are created, preserved and transformed. In order to preserve organoleptic and nutritional properties of certain nutritional substances, the housing industry could locate homes near creation systems 200 and transformation systems 400. Additionally, the housing industry could design homes which include conditioning systems and consumer systems from information provided by nutritional substance supply system 10, through nutritional substance information system 100.

Information system 1200 could provide information to nutritional substance information system 100. For example, Google Earth could provide a wealth of geographic, geopolitical, and satellite reconnaissance information to nutritional substance information system 100 for correlation with nutritional substance information from other organizations, industries, nutritional substance supply system 10, and consumer 20. Such information from Google Earth correlated with nutritional substance information could be used by governmental organization 700, marketing organization 800, nutrition advocacy organization 900, research organization 1000, non-nutritional substance industry 1100, nutritional substance supply system 10, and consumer 20.

Information system 1200 could receive information from nutritional substance information system 100 for use and correlation with information in information system 1200. For example, Google Earth could use information regarding the locations of creation of nutritional substances provided by creation system 200. Google Earth could map worldwide corn cultivation using information from nutritional substance information system 100 provided by farmers through creation system 200.

Government organization 700, marketing organization 800, nutritional advocacy organization 900, research organization 1000, non-nutritional substance industry 1100, and information system 12 are preferably a plurality of such organizations, industries and/or systems. It will be understood that the various organizations, industries and systems connected to nutritional substance information system 100 are examples of such organizations, industries and systems, and many additional organizations, industries and systems could be connected to nutritional substance information system 100.

Preferably, all such organizations, industries, systems, and consumers are operably interconnected to nutritional substance information system 100 by a computer networks. Preferably, such networks are accomplished over telecommunications systems, preferably wireless telecommunication system.

Consumer 20 goals, needs, preferences and values could be optimized through the use of information provided by nutritional substance information system 100 and/or could be furthered by providing such information to the various organizations, industries, information systems, and nutritional substance supply system 10. For example, if consumer 20 desires to eat only wild salmon, nutritional substance information system 100 could provide consumer 20 with information to allow consumer 20 to select and consume only wild salmon, avoiding farm-raised salmon. Such a consumer preference for wild salmon could be used by nutritional substance supply system 10 in making decisions on the source of salmon available to consumers.

In another example, consumer 20 may desire, following consumer's 20 political values, to only consume coffee that is grown in fair-trade, sustainable conditions. Nutritional substance information system 100 could provide information to consumer 20 to allow consumer 20 only to select and consume such products which meet consumer's 20 political values. Additionally, consumer's 20 political values which influencing consumer's 20 selection and consumption of coffee, could be collected by nutritional substance information system 100 and provided to nutritional substance supply system 10 to affect how coffee beans are produced.

Unless the context clearly requires otherwise, throughout the description and the claims, the words “comprise,” “comprising,” and the like are to be construed in an inclusive sense (i.e., to say, in the sense of “including, but not limited to”), as opposed to an exclusive or exhaustive sense. As used herein, the terms “connected,” “coupled,” or any variant thereof means any connection or coupling, either direct or indirect, between two or more elements. Such a coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize While processes or blocks are presented in a given order in this application, alternative implementations may perform routines having steps performed in a different order, or employ systems having blocks in a different order. Some processes or blocks may be deleted, moved, added, subdivided, combined, and/or modified to provide alternative or sub-combinations. Also, while processes or blocks are at times shown as being performed in series, these processes or blocks may instead be performed or implemented in parallel, or may be performed at different times. Further any specific numbers noted herein are only examples. It is understood that alternative implementations may employ differing values or ranges.

The various illustrations and teachings provided herein can also be applied to systems other than the system described above. The elements and acts of the various examples described above can be combined to provide further implementations of the invention.

Any patents and applications and other references noted above, including any that may be listed in accompanying filing papers, are incorporated herein by reference. Aspects of the invention can be modified, if necessary, to employ the systems, functions, and concepts included in such references to provide further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

While certain aspects of the invention are presented below in certain claim forms, the applicant contemplates the various aspects of the invention in any number of claim forms. For example, while only one aspect of the invention is recited as a means-plus-function claim under 35 U.S.C. §112, sixth paragraph, other aspects may likewise be embodied as a means-plus-function claim, or in other forms, such as being embodied in a computer-readable medium. Any claims intended to be treated under 35 U.S.C. §112, ¶ 6 will begin with the words “means for.” Accordingly, the applicant reserves the right to add additional claims after filing the application to pursue such additional claim forms for other aspects of the invention.

1. An information system for nutritional substances comprising:
information storage system containing information regarding a particular nutritional substance;
identifier for identifying the particular nutritional substance; and
retriever for retrieving the information regarding a particular nutritional substance.

2. An information system according to claim 1 wherein the information storage system is a multidimensional database.

3. An information system according to claim 1 wherein the identifier comprises:
identifying on or part of the particular nutritional substance; and
reader for reading the identifier.

4. An information system according to claim 1 wherein the retriever is a wireless telecommunication system.

5. An information system for nutritional substances comprising:
information storage system containing information regarding a particular nutritional substance;
identifier for identifying the particular nutritional substance; and
retriever for retrieving the information regarding a particular nutritional substance,
wherein the information storage system also contains information about the consumer of the nutritional substance.

6. An information system according to claim 5 wherein the information storage system is a multidimensional database.

7. An information system according to claim 5 wherein the means for identifier comprises:
an identifying mark on or part of the particular nutritional substance; and
reader for reading the identifier.

8. An information system according to claim 5 wherein the retriever is a wireless telecommunication system.

9. An information system for nutritional substances comprising:
information storage system containing information regarding a particular nutritional substance;
identifier for identifying the particular nutritional substance; and
retriever for retrieving the information regarding a particular nutritional substance,
wherein the information storage system also contains information about the consumer of the nutritional substance.

10. An information system according to claim 9 wherein the information storage system is a multidimensional database.

11. An information system according to claim 9 wherein the identifier comprises:
an identifier on or part of the particular nutritional substance; and
reader reading the identifier.

12. An information system according to claim 9 wherein the retriever is a wireless telecommunication system.

13. An information system for nutritional substances comprising an information storage system containing information regarding a particular nutritional substance operably connected to one, or more, of the following nutritional substance systems:
creation system for creation of nutritional substances;
preservation system for the packaging and shipping nutritional substances;
transformation system for the processing of nutritional substances;
conditioning system for the consumer preparation of nutritional substances;
consumption system for the consumption of nutritional substances;
and one, or more, of the following non-nutritional substance systems:
government organization
marketing organization
nutritional advocacy organization
research organization
non-nutritional substance industry
non-nutritional substance information system
wherein the information storage system receives and transmits information regarding said particular nutritional substance between said nutritional substance systems and said non-nutritional substance systems.

14. An information system for nutritional substances comprising an information storage system containing nutritional, organoleptic and/or aesthetic values a particular nutritional substance operably connected to one, or more, of the following nutritional substance systems:
creation system for creation of nutritional substances;
preservation system for the packaging and shipping nutritional substances;
transformation system for the processing of nutritional substances;
conditioning system for the consumer preparation of nutritional substances;
consumption system for the consumption of nutritional substances;
and one, or more, of the following non-nutritional substance systems:
government organization
marketing organization
nutritional advocacy organization
research organization
non-nutritional substance industry
non-nutritional substance information system
wherein the information storage system receives and transmits nutritional, organoleptic and/or aesthetic values regarding said particular nutritional substance between said nutritional substance systems and said non-nutritional substance systems.

15. A method of dynamically determining a price for a nutritional substance comprising the steps of:
obtaining source information for a particular nutritional substance;
obtaining non-nutritional substance information related to the particular nutritional substance;
determining a price for the nutritional substance using said source information and said non-nutritional substance information.

16. A method of dynamically determining a price for a nutritional substance comprising the steps of:
obtaining source information for a particular nutritional substance;
obtaining market information for similar nutritional substances;
obtaining non-nutritional substance information related to the particular nutritional substance;
determining a price for the nutritional substance using said source information, market information, and said non-nutritional substance information.
